(19) United States
(12) Patent Application Publication
(10) Pub. No.: US 2022/0246019 A1
(43) Pub. Date: Aug. 4, 2022

(54) VEHICLE AND OCCUPANT TEMPERATURE MONITORING AND ALERT DEVICE

(71) Applicants: Keenen Millsapp, Norfolk, VA (US); Karen Sconiers, Matteson, IL (US)

(72) Inventors: Keenen Millsapp, Norfolk, VA (US); Karen Sconiers, Matteson, IL (US)

(21) Appl. No.: 17/541,372

(22) Filed: Dec. 3, 2021

Related U.S. Application Data
(60) Provisional application No. 63/145,755, filed on Feb. 4, 2021.

(51) Int. Cl. G08B 21/22; G08B 21/24; G08B 21/02; G06V 20/59; G06V 40/10; G06V 40/20; H04N 5/33

(52) U.S. Cl. CPC G08B 21/22; G08B 21/24; G08B 21/0211; G08B 21/0236; H04N 5/33; G06V 20/593; G06V 40/103; G06V 40/20; G08B 21/0277

(57) ABSTRACT

The present invention relates to a safety device for a child and/or pet left in a vehicle. The safety device detects a vehicle's interior temperature and occupant's temperature. More specifically, when the interior temperature of the vehicle is equal to or greater than a threshold value, an alarm is generated by the device. Additionally, a wireless alert is sent to a remote peripheral electronic device. The occupant's body temperature is also measured and can be used for transmitting the emergency alert signal. The device also features a motion sensor for sensing any motion within the vehicle and a camera to capture the images of the occupant in the vehicle. The device can be pre-installed or retrofitted in a vehicle.

### CROSS-REFERENCE TO RELATED APPLICATION

The present application claims priority to, and the benefit of, U.S. Provisional Application No. 63/145,755, which was filed on Feb. 4, 2021 and is incorporated herein by reference in its entirety.

### FIELD OF THE INVENTION

The present invention relates generally to the field of warning systems. More specifically, the present invention relates to a thermal image scanner device for vehicles that senses body heat/temperature and the audible sound of a child or a pet that has been left unattended in the vehicle for a length of time and alerts the vehicle owners to take immediate action to rescue the unattended child/pet. The thermal image scanner device comprises a thermal sensor, a camera, an infrared sensor, a sound detection sensor, a speaker, a plurality of wireless modules, etc. The thermal image scanner device ensures that an unattended child and/or pet left in the vehicle does not result in an injury or death. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, many jurisdictions within the United States require infants and/or children of a certain age to be strapped into a child's car seat when in a vehicle. Although said guidelines are created for the protection of infants and/or children, there may be certain situations in which said guidelines may cause harm to the infants and/or children they intend to protect. For example, in circumstances where a vehicle owner parks a vehicle and forgets to remove the infant and/or child strapped in the child's car seat, the infant and/or child is left unattended in the vehicle for an unknown length of time. Further, in the summer months and in hot climates, the child and/or infant left inside the vehicle can suffocate due to the rising temperature inside the vehicle if the vehicle owner leaves the vehicle for an extended length of time.

Similarly, pets may be brought along by their pet owners when traveling to different places and/or running errands. However, pet owners may leave their pets inside their vehicle knowingly or unknowingly while running errands or traveling. If the pet owner does not return to his or her vehicle in a specific amount of time, the interior temperature of the vehicle will increase, thereby causing discomfort and possible injury (e.g. heat stroke) to the pet. If the pet remains locked inside the vehicle during extreme heat conditions, the interior temperature of the vehicle may rise high enough that the pet will suffocate and die.

Further, no matter how careful or responsible a parent, vehicle owner or pet owner may be, accidents may still occur and a child and/or pet can accidentally be left unattended in a hot vehicle. Further, without any kind of an alert system, children and/or pets may be forgotten in hot cars for long time periods. If left unattended in the vehicle for an extended length of time, the child and/or pet may suffer serious injury or even death.

Therefore, there exists a long-felt need in the art for a vehicle warning system that detects the presence of any infant, child or pet left unattended inside a vehicle. There is also a long-felt need in the art for a vehicle alert system that monitors if a pet and/or child is left inside the vehicle, and if so, alerts the vehicle owner. Additionally, there is a long-felt need in the art for a vehicle alert system that ensures that the infants and pets are not left unattended in vehicles for an extended length of time, but wherein the system does produce false alarms. Further, there is a long felt need in the art for a vehicle alert system that prevents heatstroke, suffocation, serious injuries and even death to infants and pets that are left unattended inside the vehicle for an extended length of time, and ensures that vehicle owners take immediate rescue measures to protect the infants and pets from suffocation inside hot vehicles.

The subject matter disclosed and claimed herein, in one embodiment thereof, comprises a vehicle occupant protection device that is configured to alerting drivers, parents and emergency services that a child, pet or other person has been left unattended in a vehicle. The device comprises a single housing component that is further comprised of a plurality of sensors such as: a thermal sensor for measuring the interior temperature of the vehicle, an infrared sensor for measuring the temperature of the occupant, a motion sensor for sensing any motion in the vehicle, etc. Additionally, the vehicle occupant protection device includes a timer preconfigured with a timer value, a camera to capture images of the interior of the vehicle and various failsafe mechanism to prevent false alarms. The device also includes a wireless communication module for establishing a wireless communication channel with a remote peripheral device wherein once established, a notification is transmitted to the remote peripheral device identifying the temperature threshold value detected by the thermal sensor and/or the infrared sensor for the preconfigured timer value.

In this manner, the novel vehicle occupant protection device of the present invention accomplishes all of the forgoing objectives, and provides a relatively safe, easy and convenient solution of identifying the presence of any child and/or pet being left inside a vehicle, and ensures the child and/or pet does not remain unattended in the vehicle for an extended length of time. Additionally, the vehicle occupant protection device sends alerts to the vehicle owner or other concerned persons, notifying them that an unattended child and/or pet has been left inside the vehicle. Accordingly, the vehicle owner or other concerned persons can take immediate action and remove the child and/or pet from the vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle occupant protection device. The device is configured to alert drivers, parents and/or emergency services that a child, pet or other person has been left unattended in a vehicle. The device further comprises a housing component comprising a thermal sensor for measuring the interior temperature of the vehicle, an infrared sensor for measuring the temperature of the occupant, a motion sensor to sense any motion in the vehicle, a timer preconfigured with a timer value, a camera to capture images of the interior of the vehicle and a wireless communication module for establishing a wireless communication channel with a remote peripheral device. A notification is further transmitted to a remote peripheral device when the thermal sensor and/or the infrared sensor detects a corresponding temperature threshold value for the preconfigured timer value. Typically, the thermal sensor has a threshold value of approximately 105° F. and the infrared sensor has a threshold value of approximately 95° F.

In yet a further embodiment, a method for transmitting a temperature-based alert to a remote electronic device is disclosed. The method comprises installing a temperature monitor and alert device inside a vehicle, monitoring the interior temperature of the vehicle using a thermal sensor housed within the temperature monitor and alert device, monitoring motion within the vehicle using a motion sensor, activating a camera when the motion is detected, activating an alarm when the interior temperature is equal to or greater than a preset temperature threshold for a predetermined timer value such as sixty seconds, and transmitting an alert signal to a remote electronic device, wherein the remote electronic device comprises an installed software application that is paired with the temperature monitor and alert device. The method further comprises activating a built-in alarm when the interior temperature is equal to or greater than a preset temperature threshold, and transmitting a signal to emergency services when the built-in alarm is activated. In one embodiment, the alarm or alert can be one of a group of alerts or alarms comprising at least one of lights, buzzers, music, sirens and/or a recorded message. A short-range communication process or a long-range communication process can be used by the device of the present invention to transmit an alert message to a remote device.

In another embodiment of the present invention, a child or pet safety device which can be retrofitted in a vehicle is disclosed. The device comprises a processor configured to receive sensor values from a plurality of built-in sensors, wherein the sensors include a thermal sensor, an infrared sensor, a motion sensor, a fire sensor and a vehicle lock detection sensor. Further, the device generates a wireless alert signal when the thermal sensor and the infrared sensor measures interior temperature values equal to or greater than their corresponding temperature threshold values, which have been previously determined to be unsafe for the child or the pet left in the unattended vehicle. The device also generates an alert when fire or smoke is detected in the vehicle, even when motion is not detected by the motion sensor. In further embodiments, the device can be integrated into a child safety seat to easily monitor the presence of a child using a motion sensor, and the temperature can be monitored by a thermal sensor and/or an infrared sensor. Further, the device may be installed on the ceiling of a vehicle, allowing the built-in camera to capture images of the vehicle's interior, and wherein the thermal sensor scans the interior temperature of the vehicle and the infrared sensor detects the body temperature of any occupants.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram showing exemplary components and sensors of the vehicle occupant protection device of the present invention in accordance with the disclosed architecture;

FIG. 2 illustrates a schematic diagram showing the wireless connection of the vehicle occupant protection device of the present invention with a handheld peripheral device in accordance with the disclosed architecture;

FIG. 3 illustrates a flow diagram showing the method for generating alerts and notifications using the vehicle occupant protection device in accordance with the disclosed architecture;

FIG. 4 illustrates a flow diagram showing the method for generating alerts using the thermal image scanner of the vehicle occupant protection device in accordance with the disclosed architecture; and

FIG. 5 illustrates a flow diagram showing the method for generating alerts based on monitoring the vehicle's interior temperature using the thermal image scanner of the vehicle occupant protection device in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a warning system that detects the presence of an infant, child or pet left unattended inside a vehicle, and that also alerts the vehicle owners of the possible need to remove the pet and/or child from the vehicle. Additionally, there is a long-felt need in the art for a warning device that ensures that infants and/or pets are not left unattended in vehicles for an extended length of time, and wherein the device does not produce any false alarm alerts. Further, there is a long felt need in the art for a warning device that prevents infants and/or pets from suffering from heatstroke, suffocation, serious injuries and even death, due to being left unattended inside a vehicle for an extended length of time. Finally, there is a long felt need in the art for a warning device that prevents infants and/or pets from being left inside a vehicle for an extended length of time, and ensures that vehicle owners take immediate action to remove the infants and/or pets from the inside of vehicles.

The present invention, in one exemplary embodiment, comprises a vehicle occupant protection device which can be retrofitted in a vehicle. The device comprises a processor configured to receive sensor values from a plurality of built-in sensors, wherein the sensors include a thermal sensor, an infrared sensor, a motion sensor, a fire sensor and a vehicle lock detection sensor. Further, the device generates a wireless alert signal when the thermal sensor and the infrared sensor measure temperature values equal to or greater than their corresponding temperature threshold values. The device also generates an alert when fire or smoke is detected in the vehicle, even when motion is not detected by the motion sensor.

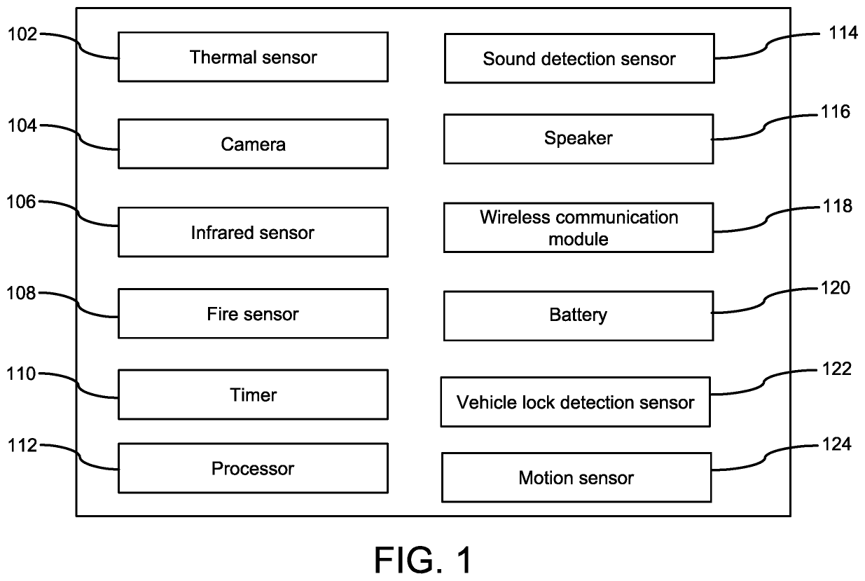

Referring initially to the drawings, FIG. 1 illustrates a block diagram showing the exemplary components and sensors of the vehicle occupant protection device 100 of the present invention in accordance with the disclosed architecture. The device 100 is designed to alert vehicle owners (e.g. parents) that a child and/or a pet has been left unattended in a vehicle. The device 100 is a portable device and is designed to assist vehicle owners by preventing injuries and deaths due to heatstroke of children and/or pets left in a hot vehicle. The device 100 can be attached anywhere inside the vehicle, e.g., the dashboard, cupholders, etc., or any other position within the interior of the vehicle. The device 100 can also be manufactured or integrated into a child's safety seat and/or installed in the passenger side or roof of a vehicle.

The device 100 has a built-in thermal/temperature sensor 102 for monitoring the interior temperature of the vehicle in which the device 100 is installed. The thermal sensor 102 detects the interior temperature of the vehicle in real-time, and can determine if the interior vehicle temperature exceeds a preset temperature value. The alert device 100 further comprises a camera 104 for capturing images of the interior of the vehicle, i.e., images showing the child and/or pet locked in the vehicle. The camera 104 also provides depth perception and can scan and identify items covering the child and/or pet, i.e., a blanket covering a child. The device 100 is made up of a rugged material such as metal, moulded thermoplastic or any other suitable material as is known in the art such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. The components of the device 100 are also housed within a single housing structure which is removably secured to an interior of a vehicle 202.

The device 100 is also comprised of an infrared sensor 106 which detects the body heat of an occupant in the vehicle. The infrared sensor 106 is used to remove false alerts and can identify any change in temperature within the interior of the vehicle, i.e., a change in temperature caused by the occupant having a fever, but the interior temperature of the vehicle as measured by the thermal sensor 102 is less than the predefined threshold so an alert is not sent. The device 100 also comprises a fire sensor 108 that monitors any smoke and/or heat caused by a fire in the engine and/or battery compartments of the vehicle. The device 100 also comprises a timer module 110 to determine how much time a vehicle occupant, such as a child and/or pet, has been left unattended inside the vehicle.

A processor 112 further communicates with and receives signals from the aforementioned sensors 102, 106, 108 and processes/analyzes said signals. The processor 112 can also digitize any analog signals if analog sensors are utilized. The processor 112 may also perform rudimentary processing of the sensor data, if desired, for deciding what alerts and/or other information is to be transmitted from the device 100. The device 100 also comprises a sound detection sensor 114 that monitors the audible sounds produced in the interior of the vehicle, i.e., the audible sounds of the child and/or the pet inside the vehicle which can be used as an additional indication of the presence of an occupant in the vehicle. The device 100 further has a speaker 116 that can be activated individually and/or connected to the device 100 for activating a horn or an alarm of the vehicle if the presence of an occupant is detected and the interior temperature exceeds a preset value.

A wireless communication module 118 also enables direct communication and data exchange between a vehicle and a vehicle owner's electronic smart devices, such as a personal digital assistant, smartphone or any other type of electronic smart device. The device 100 also comprises a battery source 120 for providing power to all the components described in the present embodiment of the alert device 100. The battery source 120 also comprises a back-up function, which alerts a user when the battery is low and needs to be replaced. Further, a vehicle lock detection sensor 122 is used to monitor whether the vehicle doors are locked or unlocked. A motion sensor 124 is also used for detecting an occupant inside the locked vehicle, and can be used in collaboration with the infrared sensor 106 to eliminate false alarms/alerts while attempting to detect an occupant.

It should be noted that the thermal sensor 102, infrared sensor 106 and fire sensor 108 are used for activating alarms to protect vehicle occupants, such as newborns, children, infants, elderly people and pets from unsafe hot and cold temperatures. The device 100 does not require car seats with built-in sensors for operation. An occupant positioned in any part of the vehicle, such as the front seat, back seat, and/or rear compartments such as third row seats and the like can be easily located using the device 100. The device 100 also does not necessarily require permanent installation within a vehicle, and can be retrofitted into any existing vehicle. The device 100 can be removed from the vehicle when not needed, and/or placed in another vehicle depending on the wants and/or needs of a user. The device 100 can further be connected to existing vehicle circuitry using a wireless or a wired connection allowing the device 100 to activate alarms using the existing horn or security system of the vehicle.

Furthermore, use of the thermal sensor 102 and the infrared sensor 106 in combination prevents false alarms/alerts from occurring. Additionally, the vehicle lock-detection sensor 122 can be internally connected to the locks of the vehicle and allows other sensors (such as the thermal sensor 102 and infrared sensor 106) to sense the interior temperature of the vehicle and/or an occupant when the vehicle is locked. The lock-detection sensor 122 can also be a pressure measuring sensor that detects a change in air pressure when the doors of the vehicle are locked. Furthermore, the processor 112 of the device 100 communicates with and receives signals from all sensors disclosed in the alert device 100, i.e., thermal sensor 102, infrared sensor 106, fire sensor 108, sound detection sensor 114, vehicle lock detection sensor 122 and motion sensor 124 and processes/analyzes these signals for use in the device 100.

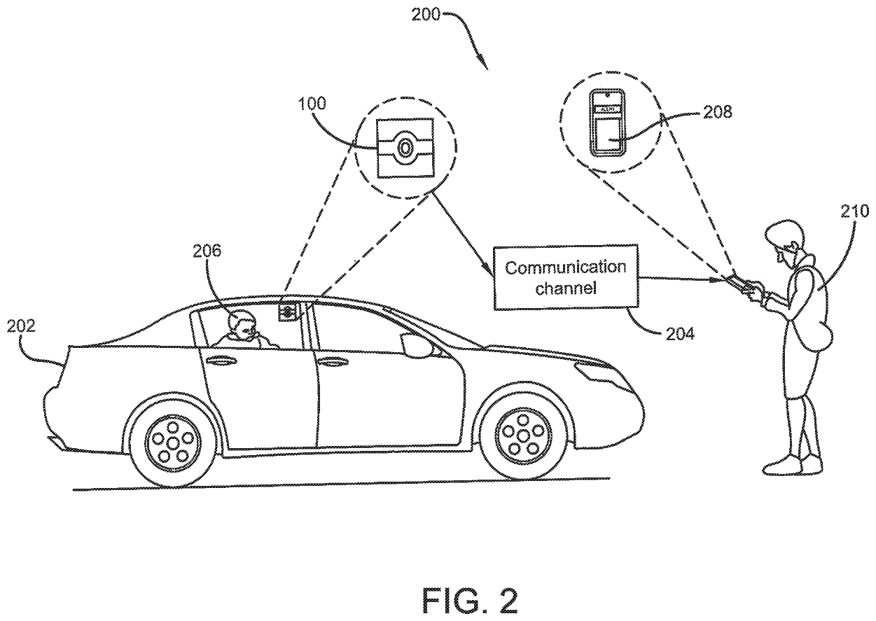

FIG. 2 illustrates a schematic diagram showing the wireless connection of the vehicle occupant protection device 100 of the present invention with a handheld peripheral device in accordance with the disclosed architecture. As shown in FIG. 2, the device 100 can be retrofitted inside an interior location of a vehicle 202 such as a headrest, ceiling, child safety seat or any other suitable location in the vehicle, and can wirelessly connect to the remote peripheral device 208 using a wireless communication channel 204. The wireless communication channel 204 can be a short-range communication channel such as Bluetooth, or it can use the wireless transceiver of the vehicle 202 to connect to the peripheral device 208 of the vehicle owner 210. The device 100 can also generate an “SOS” signal to transmit to nearby emergency authorities if necessary.

The remote peripheral device 208 may also have a companion software application which receives alerts and notifications from the device 100. Specifically, one or more sensors from the device 100 can detect the presence of an occupant 206 within the vehicle, as well as the body temperature of the occupant 206. If a threshold temperature is reached, the device 100 automatically sends an alert to the remote peripheral device 208 (e.g. cell phone or other smart device) of the vehicle owner 210. The alert can be in the form of a plurality of alarms sent to the remote peripheral device 208, to notify the user that a child 206 or a pet has been left in a hot vehicle 202. Further, users such as the vehicle owner 210 receive real-time alerts on their remote peripheral devices 208. The alerts and/or notifications shown on the software application may be in the form of a push notification, audio alert, or a visual alert.

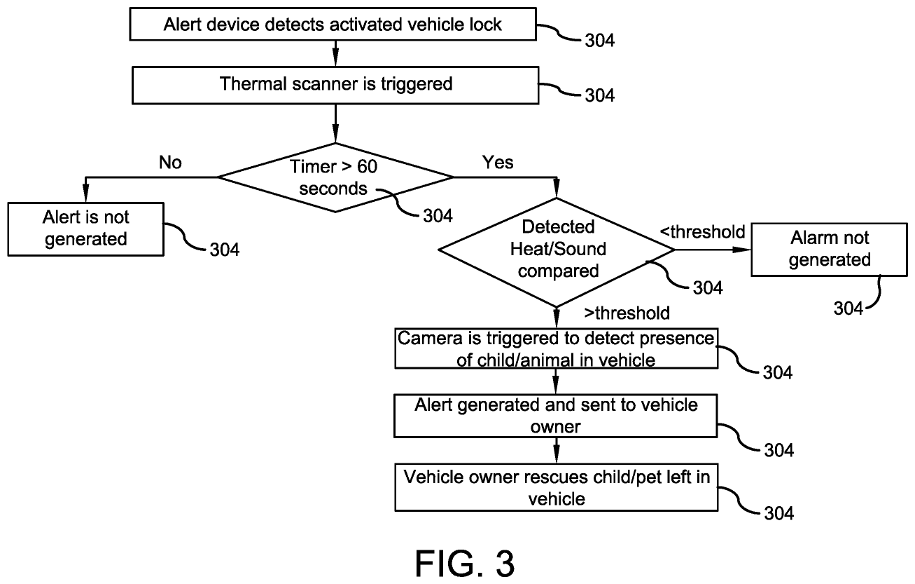

FIG. 3 illustrates a flow diagram disclosing the method for generating alerts and notifications using the vehicle occupant protection device 100 in accordance with the disclosed architecture. Initially, the device 100 is connected to the vehicle circuitry. At 301, the alert device detects whether the vehicle doors are locked or unlocked. If locked, then at 302 the thermal scanner is triggered, and temperature monitoring of the vehicle and the occupant is initiated. At 303, the timer is initiated, and it is determined if the vehicle is locked for a predetermined time period such as sixty seconds; or if the thermal image scanner has been triggered and started scanning the vehicle for a predetermined time duration. If the time period for which the vehicle is locked or the scanning duration is less than the predetermined time, then at 304 an alert is not generated. Further, if the time period for which the vehicle is locked or the thermal image scanner is scanning the vehicle and its occupant is more than the predetermined time period, then at 305 the temperature of the occupant and the sound detected by the thermal image scanner is compared to a predefined threshold. Then at 306, if it is determined that the heat and sound detected by the thermal scanner device is less than the predetermined threshold, no alerts or alarms are generated.

If the heat and sound detected by the thermal scanner exceeds the predetermined threshold, then at 307 the camera 104 is triggered to detect the presence of the child and/or animal inside the vehicle. Once the camera 104 has detected the presence of the child and/or animal, at 308 an alert or alarm is generated and sent to the remote peripheral device 208 with the software application installed. The alert or notification shown on the software application may be in the form of a push notification, audio alert or visual alert. At 309, the received alert is seen and reviewed by one or more parents or vehicle owners, who then can provide the immediate action needed for the unattended child and/or pet left inside the vehicle.

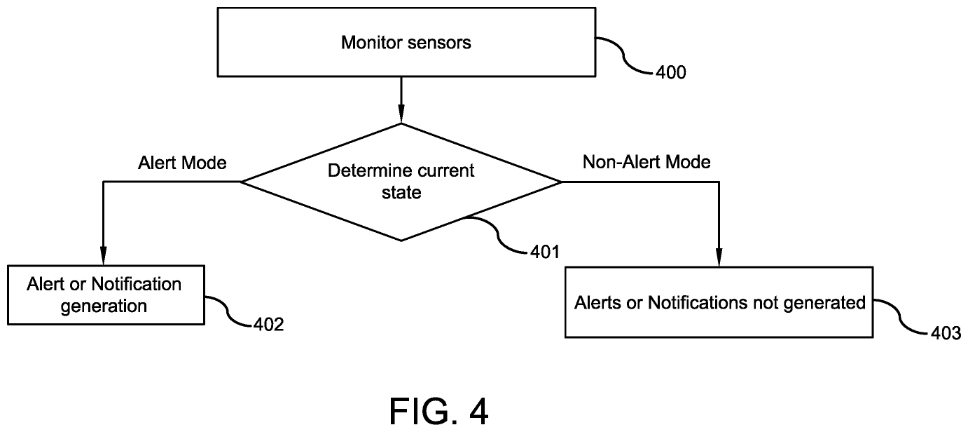

FIG. 4 illustrates a flow diagram disclosing the method for generating alerts using the device 100 of the present invention in accordance with the disclosed architecture. At 400, a plurality of sensors, such as a motion sensor 124, thermal sensor 102 and infrared sensor 106 are housed within the device 100 wherein said sensors 102, 106, 124 monitor the child and/or animal occupant inside the vehicle. Monitoring includes determining a child's body temperature, as well as the sound and/or temperature inside the vehicle. Then at 401, the processor determines the current alert state based on the monitoring of the data collected by the plurality of sensors 102, 106, 124. Generally, the alert state corresponds to an alert mode or a non-alert mode, wherein based on the child and/or animal occupant status determined via the data collected by the plurality of sensors 102, 106, 124, it is determined whether to send an alert or not. If the data from the plurality of sensors 102, 106, 124 indicate that the child and/or animal inside the vehicle is in danger, then at 402 an alert or notification is generated. Specifically, the processor of the alert device produces an alert or alarm which is sent to one or more remote peripheral devices 208.

Further, if the data from the plurality of sensors 102, 106, 124 indicates that the child and/or animal inside the vehicle is not in danger, then at 403 an alert or notification is not generated. Specifically, the data from the plurality of sensors 102, 106, 124 indicates that the child and/or animal is not left inside the vehicle, or the child and/or animal was left for a very short period of time inside the vehicle. The processor then determines not to generate an alert or alarm to the one or more remote peripheral devices 208. It should be noted that the processor of the device 100 receives the sensor 102, 106, 124 information and transmits the corresponding alerts and notifications to the electronic device and/or emergency services. The processor also provides an instruction to the vehicle horn to activate, to generate an audible alarm.

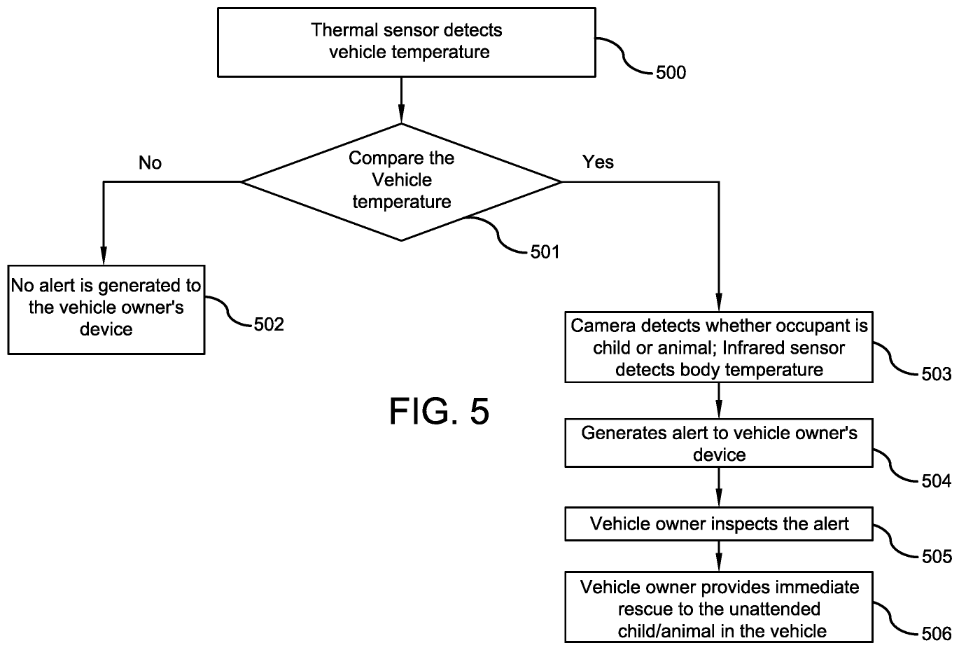

FIG. 5 illustrates a flow diagram disclosing the method for generating alerts based on the vehicle temperature monitored using the device 100 of the present invention in accordance with the disclosed architecture. At 500, the thermal sensor 102 measures the interior temperature of the vehicle. Then at 501, the device 100 compares the detected interior vehicle temperature with a predetermined temperature threshold such as approximately 95° F. The predetermined temperature threshold is determined based on the maximum safe temperature, in combination with environmental conditions which are suitable for a newborn or young child. However, the predetermined temperature threshold can be set at any value of temperature that is appropriate to assure timely activation of the alarm and/or transmission of alerts to prevent the interior temperature from reaching a dangerous temperature for occupants left inside the vehicle. If the interior vehicle temperature is less than the predetermined temperature threshold, then at 502 no alert is generated to the vehicle owner's electronic device 208.

If the interior vehicle temperature exceeds the predetermined temperature threshold, then at 503 the camera 104 is triggered to detect the presence of a child and/or a pet inside the vehicle. Additionally, an infrared sensor 106 then determines the body temperature of the occupant. Once the camera 104 has detected the presence of the child and/or pet, then at 504 an alert or an alarm is generated and sent to the electronic device of the vehicle owner, which has the corresponding software application installed. The alert or notification shown on the software application may be in the form of a push notification or audio alert, depending on the wants and/or needs of a user. At 505, the received alert is seen and reviewed by one or more individuals, including the vehicle owner. At 506, these individuals can then provide immediate rescue to the unattended child and/or animal left inside the vehicle.

The vehicle occupant protection device 100 of the present invention is useful for providing real-time alerts in different scenarios where an occupant is left locked in a vehicle for an extended length of time. The device 100 of the present invention can also be part of an onboard dashboard or monitoring system of a vehicle, wherein temperature settings, alarms and alarm notification features are programmed into the onboard dashboard, pre-programmed at the factory or dealer-installed. In one embodiment, the device 100 may be positioned near the rear view mirror of the vehicle, or at any other suitable location within the cabin area.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle occupant protection device” and “device”, are interchangeable and refer to the vehicle occupant protection device 100 of the present invention.

Notwithstanding the forgoing, the vehicle occupant protection device 100 of the present invention can be of any suitable size and configuration as is known in the art without affecting the overall concept of the invention, provided that it accomplishes the above-stated objectives. One of ordinary skill in the art will appreciate that the size, configuration, and material of the vehicle occupant protection device 100 as shown in FIGS. 1-5 are for illustrative purposes only, and that many other sizes and shapes of the vehicle and occupant temperature monitoring and alert device 100 are well within the scope of the present disclosure. Although the dimensions of the vehicle occupant protection device 100 are important design parameters for user convenience, the vehicle occupant protection device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle and occupant temperature monitoring and alert device that alerts a vehicle owner that an occupant has been left in a vehicle, the vehicle and occupant temperature monitoring and alert device comprising:
a thermal sensor for monitoring an interior temperature of the vehicle;
an infrared sensor for detecting a body heat of the occupant in the vehicle;
a fire sensor for monitoring a fire in the vehicle;
a camera for capturing an image of an interior of the vehicle;
a timer for determining how much time the occupant has been left unattended in the vehicle; and
a processor in communication with each of the thermal sensor, the infrared sensor, the fire sensor, the camera and the timer.

2. The vehicle and occupant temperature monitoring and alert device of claim 1 further comprising a sound detection sensor.

3. The vehicle and occupant temperature monitoring and alert device of claim 1 further comprising a vehicle lock detection sensor.

4. The vehicle and occupant temperature monitoring and alert device of claim 1 further comprising a motion sensor.

5. The vehicle and occupant temperature monitoring and alert device of claim 1 further comprising a wireless communication module in wireless communication with a remote electronic device.

6. The vehicle and occupant temperature monitoring and alert device of claim 5, wherein the remote electronic device is a personal digital assistant, a smart phone, or a tablet.

7. The vehicle and occupant temperature monitoring and alert device of claim 1 further comprising a battery.

8. The vehicle and occupant temperature monitoring and alert device of claim 1 further comprising a speaker for sounding an alarm.

9. The vehicle and occupant temperature monitoring and alert device of claim 1, wherein the vehicle and occupant temperature monitoring and alert device is secured inside the vehicle.

10. The vehicle and occupant temperature monitoring and alert device of claim 1, wherein the vehicle and occupant temperature monitoring and alert device is secured to a child's car seat inside the vehicle.

11. A vehicle and occupant temperature monitoring and alert device that alerts a vehicle owner that an occupant has been left in a vehicle, the vehicle and occupant temperature monitoring and alert device comprising:
a thermal sensor for determining an interior vehicle temperature;
a predetermined temperature threshold;
a camera;
a timer; and
a processor in communication with each of the thermal sensor, the camera and the timer.

12. The vehicle and occupant temperature monitoring and alert device of claim 11, wherein if the interior vehicle temperature exceeds the predetermined temperature threshold, then the camera is triggered to detect a presence of the occupant inside the vehicle.

13. The vehicle and occupant temperature monitoring and alert device of claim 12 further comprising an infrared sensor for determining a body temperature of the occupant.

14. The vehicle and occupant temperature monitoring and alert device of claim 13, wherein once the camera has detected the presence of the occupant, an alert is generated.

15. The vehicle and occupant temperature monitoring and alert device of claim 14, wherein the alert is sent to a remote electronic device via a wireless communication module.

16. The vehicle and occupant temperature monitoring and alert device of claim 15 further comprising a battery.

17. The vehicle and occupant temperature monitoring and alert device of claim 16 further comprising a speaker.

18. The vehicle and occupant temperature monitoring and alert device of claim 17 further comprising a motion detector.

19. The vehicle and occupant temperature monitoring and alert device of claim 18 further comprising a vehicle lock detector.

20. A vehicle and occupant temperature monitoring and alert device that alerts a vehicle owner that an occupant has been left in a vehicle, the vehicle and occupant temperature monitoring and alert device comprising:
a thermal sensor for monitoring an interior temperature of the vehicle;
an infrared sensor for detecting a body heat of the occupant in the vehicle;
a camera for capturing an image of an interior of the vehicle;
a wireless communication module in communication with a remote electronic device; and
a processor in communication with each of the thermal sensor, the infrared sensor, the camera and the wireless communication module.
